(19) United States
(12) Patent Application Publication
(10) Pub. No.: US 2020/0088349 A1
(43) Pub. Date: Mar. 19, 2020

(54) LUBRICATING OIL PUMP DEVICE

(71) Applicant: HANSUNG PRECISION CO., LTD, Incheon (KR)

(72) Inventor: Changsun KIM, Incheon (KR)

(21) Appl. No.: 16/615,677

(22) PCT Filed: Dec. 7, 2018
(86) PCT No.: PCT/KR2018/015477

§ 371 Date: Nov. 21, 2019

(30) Foreign Application Priority Data
Dec. 28, 2017 (KR) 10-2017-0183170

(51) Int. Cl. F16N 13/04; F16N 13/06

(52) U.S. Cl. CPC F16N 13/04; F16N 2013/063; F16N 13/06

(57) ABSTRACT

A lubricating oil pump device includes a pump main body and a lubricating oil cartridge, wherein the pump main body comprises: a suction part; a discharge part; a piston; a relief valve; a pressure detection sensor; a control part; a first pipeline; an inlet-side check valve, between the suction part and the discharge part, for preventing lubricating oil, having moved to the first pipeline, from flowing back to the lubricating oil cartridge; an outlet-side check valve, between the suction part and the discharge part, for preventing the lubricating oil, having been supplied to a lubricating oil supply pipe, from flowing back to the first pipeline; a second pipeline; a third pipeline; and a fourth pipeline, the pressure detection sensor detects pressure inside the pump main body through the fourth pipeline.

### CROSS-REFERENCE TO RELATED APPLICATION

This application claims priority to and the benefit of Korean Patent Application No. 2017-0183170, filed on Dec. 28, 2017, the disclosure of which is incorporated herein by reference in its entirety.

### BACKGROUND

### 1. Field of the Invention

The present invention relates to a lubricating oil pump device which supplies a lubricating oil to a variety of machines, and more particularly to a lubricating oil pump device capable of detecting and relieving a high pressure generated while a lubricating oil is supplied.

### 2. Discussion of Related Art

In machines such as an injection molding machine, which injects a resin or a metal, a lathe, or the like, it is necessary to supply a lubricating oil during an operation of a machine. Generally, in a lubricating oil pump device, a lubricating oil pump is used for supplying a lubricating oil to machines such as an injection molding machine, which injects a resin, a metal, or the like. Generally, the lubricating oil pump includes a single piston which discharges a lubricating oil while being repetitively moved forward and backward by pressure application and pressure relief of the lubricating oil and one outlet corresponding to the piston and supplies the lubricating oil to a lubricating oil pipe W in which a plurality of single metering valves V known as having one shot of discharge amount in a range of 0.03 to 1.5 ml are embedded in a plurality of parts corresponding thereto.

Since the single metering valve V is operated by applying and relieving a pressure of a lubricating oil and discharges the lubricating oil, it is necessary to relieve the pressure. Accordingly, a lubricating oil pump device capable of relieving a pressure is used.

A conventional lubricating oil pump device capable of relieving a pressure includes a pump body in which a lubricating oil transfer path and a pressure relief path are formed, a lubricating oil cartridge connected to the lubricating oil transfer path of the pump body, an actuator which moves a piston forward and backward, a relief valve including a shaft, a pressure sensor installed behind the relief valve, and a control portion which controls forward and backward movement of the piston. The conventional lubricating oil pump device measures a pressure at the lubricating oil transfer path in the pump body using the pressure sensor installed behind the relief valve used for adjusting a pressure. In more detail, the conventional lubricating oil pump device senses whether a maximum pressure occurs by using whether the shaft of the relief valve comes into contact with the pressure sensor.

When the shaft of the relief valve comes into contact with the pressure sensor, the pressure sensor transmits the contact of the shaft to the control portion and the control portion determines that the maximum pressure occurs in the pump body and controls the actuator to move the piston backward. Also, the piston moved backward by the actuator opens the pressure relief path in the pump body and relieves a pressure inside the pump body.

However, a pressure measuring method used by the conventional lubricating oil pump device has a problem in which a pressure is relieved only when the relief valve is maximally moved backward by a pressure such that the shaft in the relief valve comes into contact with the pressure sensor. That is, there is a problem in which the piston is moved hindmost and relieves a pressure by opening the pressure relief path only when the pressure inside the pump body reaches a maximum point. In other words, the conventional lubricating oil pump device uses a method of using a safety relief valve which relieves a pressure only when a pressure inside the device reaches a maximum value. However, in this method, since the shaft of the relief valve used for protecting the safety of the pump is used at a maximally reached pressure while doubling as a shaft of a pressure detection sensor which controls a pressure used for each pipe length, when the pressure detection sensor does not work, it is impossible to estimate a particular pressure at which a pressure thereinside may damage the device. In addition, when the pressure is greater than or equal to the particular pressure, it is impossible to relive the pressure thereinside.

Also, due to the above problem, the pressure inside the lubricating oil pump device is not appropriately relieved such that the lubricating oil pump device in which a sealing function is very significant may be damaged.

### SUMMARY OF THE INVENTION

The present invention is directed to provide a lubricating oil pump device capable of detecting and relieving a high pressure generated while a lubricating oil is supplied.

According to one aspect of the present invention, there is provided a lubricating oil pump device including a pump body (100) and a lubricating oil cartridge (200). Here, the pump body (100) includes a suction portion (111) which is connected to the lubricating oil cartridge (200) and receives a lubricating oil from the lubricating oil cartridge (200), a discharge portion (112) which is connected to a lubricating oil supply pipe (W) and supplies the lubricating oil to the lubricating oil supply pipe (W), a piston (150) which reciprocates in the pump body (100) to supply the lubricating oil to the pump body (100) from the lubricating oil cartridge (200), a relief valve (160) for adjusting a pressure inside the pump body (100), a pressure sensor (170) for measuring the pressure inside the pump body (100), a control portion (300) which controls an operation of the piston (150) and an operation of the relief valve (160), a first pipe (110) formed between the suction portion (111) and the discharge portion (112), an incoming side check valve which prevents the lubricating oil moved to the first pipe (110) between the suction portion (111) and the discharge portion (112) from flowing backward to the lubricating oil cartridge (200), an outgoing side check valve which prevents the lubricating oil supplied to the lubricating oil supply pipe (W) between the suction portion (111) and the discharge portion (112) from flowing backward to the first pipe (110), a second pipe (120) formed between the first pipe (110) and the relief valve (160), a third pipe (130) formed between the first pipe (110) and the piston (150), and a fourth pipe (140) formed between the first pipe (110) and the pressure sensor (170) and formed between the outgoing side check valve and the lubricating oil supply pipe (W). Here, the pressure sensor (170) senses a pressure inside the pump body (100) through the fourth pipe (140). Here, the relief valve (160) is connected to the first pipe (110) and the second pipe (120). When the detected pressure exceeds a pressure preset by a user, the control portion (300) controls an operation of the piston (150) to open the third pipe (130) using a pressure relief signal.

The relief valve (160) may include a spring and a valve shaft, and the valve shaft may include a lubricating oil transfer path for returning the lubricating oil.

The fourth pipe (140) may be formed in an area adjacent to the discharge portion (112) and may be spaced apart from and parallel to a transfer pipe at which the relief valve (160) is formed.

The fourth pipe (140) may be formed in an area adjacent to the discharge portion (112) and may be spaced apart from and perpendicular to a transfer pipe at which the relief valve (160) is formed.

According to another aspect of the present invention, there is provided a lubricating oil pump device including a pump body (100) and a lubricating oil cartridge (200). The pump body (100) includes a suction portion (111) which is connected to the lubricating oil cartridge (200) and receives a lubricating oil from the lubricating oil cartridge (200), a discharge portion (112) which is connected to a lubricating oil supply pipe (W) and supplies the lubricating oil to the lubricating oil supply pipe (W), a piston (150) which reciprocates in the pump body (100) to supply the lubricating oil to the pump body (100) from the lubricating oil cartridge (200), a relief valve (160) for adjusting a pressure inside the pump body (100), a pressure sensor (170) for measuring the pressure inside the pump body (100), a control portion (300) which controls an operation of the piston (150), a first pipe (110) formed between the suction portion (111) and the discharge portion (112), an incoming side check valve which prevents the lubricating oil moved to the first pipe (110) between the suction portion (111) and the discharge portion from flowing backward to the lubricating oil cartridge (200), an outgoing side check valve which prevents the lubricating oil supplied to the lubricating oil supply pipe (W) between the suction portion (111) and the discharge portion (112) from flowing backward to the first pipe (110), a second pipe (120) formed between the first pipe (110) and the relief valve (160), a third pipe (130) formed between the first pipe (110) and the piston (150), and a fourth pipe (140) formed between the outgoing side check valve and the pressure sensor (170) and formed between the outgoing side check valve and the lubricating oil supply pipe (W). Here, the pressure sensor (170) detects a pressure inside the pump body (100) through the fourth pipe (140) and is configured to transmit a detection signal to the control portion (300) when the detected pressure is greater than or equal to a pressure-set by a user. Here, the relief valve (160) is connected to the first pipe (110) and the second pipe (120), and the control portion (300) receives the detection signal from the pressure sensor (170) and controls an operation of the piston (150) to open the third pipe (130).

The pressure sensor (170) may include a shaft and a pressure sensor which move backward according to a pressure in order to detect a pressure generated by the discharge portion (112) adjacent to the fourth pipe (140) and may transmit a measured pressure value to the control portion (300) to maintain uniform pressure of the discharge portion (112).

The pressure detection shaft and pressure_sensor may be located on one side surface of the pump body (100) or located in a rear bracket attachment space of the pump body (100).

The lubricating oil pump device may further include a pressure detection valve (172) which measures a pressure transferred from the fourth pipe (140) through a spring adjusting screw, which sets a particular pressure, and a mobile shaft. Here, the pressure detection valve (172) may transmit the measured pressure to the pressure sensor (170).

A movement distance of the mobile shaft may be adjusted by adjusting the spring adjusting screw of the pressure detection valve (172), and settings of the particular pressure of the pressure detection valve (172) may be changed by adjusting the movement distance of the mobile shaft.

Details of other embodiments are included in a detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front view of a conventional lubricating oil pump device;

FIG. 2 is a perspective view of a lubricating oil pump device according to the present invention;

FIG. 3 is a cross-sectional view of a lubricating oil pump device according to one embodiment of the present invention;

FIG. 4 is a cross-sectional view of a lubricating oil pump device according to another embodiment of the present invention; and

FIG. 5 is a flowchart illustrating controlling, by a control portion, of the lubricating oil pump device according to the present invention.

### DETAILED DESCRIPTION OF EXEMPLARY EMBODIMENTS

The terms or words used in the specification and the claims will not be interpreted while being defined as general or lexical meanings and should be interpreted as meanings and concepts corresponding to the technical concept of the present invention. Accordingly, since embodiments disclosed in the specification and components shown in the drawings are merely exemplary embodiments of the present invention and do not represent an entirety of the technical concept of the present invention, it should be understood that a variety of equivalents and modifications capable of substituting the embodiments and the components may be present at the time of filing of the presents application.

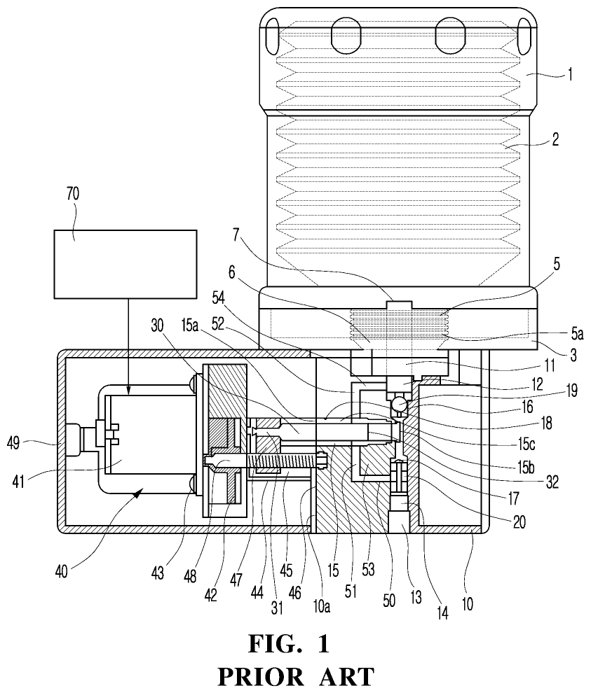

FIG. 1 is a front view of a conventional lubricating oil pump device.

Referring to FIG. 1, conventional lubricating oil pump devices each include, as shown in FIG. 1, a tank 2 which accommodates a lubricating oil formed of grease, a tank mounting portion 3 which is installed above a pump body 10 and on which the tank 2 is mounted, and a cover mounted on the tank mounting portion 3 to cover the tank 2. The tank 2 is an axially retractile resinous cartridge container, and a male screw 5a is formed at an opening portion 5. The tank mounting portion 3 includes a female screw portion 6 with which the male screw 5a of the opening portion 5 of the tank 2 is coupled to be mounted thereon. Also, the tank mounting portion 3 includes a guide pipe 7 which is inserted into the opening portion 5 of the tank 2, into which the male screw 5a is inserted and mounted and leads the lubricating oil in the tank 2 to an inlet 11 of the pump body 10.

The pump body 10 includes, as shown in FIG. 1, a suction path 12 which suctions in the lubricating oil stored in the tank 2 through the inlet 11 and a discharge path 14 which discharges the suctioned lubricating oil through an outlet 13. The inlet 11 is open above the pump body 10 and is connected to the guide pipe 7.

Also, the outlet 13 is open below the pump body 10. Also, a lubricating oil pipe is connected to the outlet 13.

Also, the pump body 10 includes a base end portion 15a located at a first side surface 10a of the pump body 10 and a cylinder portion 15 having an axial line in a lateral direction. A fore end portion 15b of the cylinder portion 15 includes an introduction hole 16 which communicates with the suction path 12 and introduces the lubricating oil from the suction path 12, and an elicitation hole 17 which communicates with the discharge path 14 and elicits the lubricating oil toward the discharge path 14. Also, a body portion 15c which forms the cylinder portion 15 is formed as a cylindrical member and engages with a hole 18 formed in the pump body 10.

An inlet check valve 19 which allows only suction is installed ahead of the introduction hole 16, and an outlet check valve 20 which allows only discharge is installed behind the elicitation hole 17.

The outlet check valve 20 includes a valve body. The valve body includes a metallic head formed having a conic support shape formed at a fore end of a rod, a rubber O-ring continuously installed at a base end of the head and fitting on the rod, and a push member which pushes the O-ring toward the base end of the head. Also, the outlet check valve 20 includes a metallic sealing surface portion which is installed next to the elicitation hole 17 of the cylinder portion 15 and comes into contact with or is separated from the head and O-ring of the valve body, a guide portion which supports the rod of the valve body to be movable in an axial direction and includes a slit-shaped path through which the lubricating oil discharged from the elicitation hole 17 passes when the head and O-ring are separated from the sealing surface portion, and a coil spring which is mounted between the guide portion and the push member and presses the head and the O-ring against the sealing surface portion.

According to the outlet check valve 20, since the metallic head and the rubber O-ring come into contact with the sealing surface portion such that the rubber O-ring is joined to the metallic sealing surface portion in addition to metallic joining between the head and the sealing surface portion, sealing is ensured that much and a countercurrent is certainly suppressed when the lubricating oil is absorbed through the introduction hole 16 so as to easily perform an operation.

In the cylinder portion 15, a piston 30 is inserted to be movable forward and backward. The piston 30 suctions the lubricating oil from the introduction hole 16 while moving backward and discharges the lubricating oil from the elicitation hole 17 while moving forward. A rear side portion 31 of the piston 30 protrudes outward from the base end 15a of the cylinder portion 15 (that is, the side surface 10a of the pump body 10) and is linked with an actuator 40 even when the piston 30 moves forward.

The actuator 40, as shown in FIG. 1, moves the piston 30 forward or backward, introduces the lubricating oil from the introduction hole 16 of the cylinder portion 15 while the piston 30 moves backward and elicits the lubricating oil from the elicitation hole 17 of the cylinder portion 15 while the piston moves forward. In more detail, the actuator 40 includes an electric motor 41 capable of rotating forward and backward. The electric motor 41 includes a driving shaft 43 rotating through a gear speed-reduction tool 42 and is fixed to a leg portion 44 erected on the first side surface 10a of the pump body 10 such that an axial line of the driving shaft 43 is parallel to an axial line of the piston 30. At the driving shaft 43 of the electric motor 41, a screw shaft 45 on the same axis extends. A fore end portion of the screw shaft 45 is rotatably supported at the first side surface 10a of the pump body 10 using a bearing 46. Also, the actuator 40 includes a link member 47 which engages with the screw shaft 45 and is fixed to and linked with the rear side portion 31 of the piston 30.

The link member 47 is slidably supported at two guide shafts 48 and is moved forward and backward by forward and backward rotation of the screw shaft 45 so as to move the piston 30 forward and backward. Due to forward and backward movement of the piston 30, a lubricating oil is supplied to a lubricant pipe connected to the outlet 13 and the outlet 13 is pressurized when the lubricating oil is supplied.

Also, the piston 30 is movable to move forward to a first position which is an advancing end of a fore end 32 of the piston 30 which moves forward and elicits the lubricating oil, to a second position at which the piston 30 is moved backward from the first position and absorbs the lubricating oil, and to a third position at which the piston 30 is moved backward from the second position. Also, the pump body 10 includes a pressure relief path 50 formed therein, which is closed by the piston 30 when the piston 30 moves between the first position and the second position and is opened by the piston 30 when the piston 30 is moved backward to the third position. Accordingly, when supplying of the lubricating oil through the lubricating oil pipe is stopped, the piston 30 may be moved backward to the third position and a pressure at the outlet 13 may be removed.

In more detail, as shown in FIG. 1, a first through hole 51 and a second through hole 52 are formed in the cylinder portion 15 of the pump body 10. The first through hole 51 and the second through hole 52 are closed by the piston 30 when the piston 30 moves between the first position and the second position and are opened when the piston 30 moves backward to the third position. Also, a first path 53, which connects the first through hole 51 to the discharge path 14, and a second path 54, which connects the second through hole 52 to the suction path 12, are formed in the pump body 10. Accordingly, the pressure relief path 50 which passes the discharge path 14, the first path 53, the cylinder portion 15, and the second path 54 and reaches the suction path 12 when the piston 30 moves backward to the third position may be formed.

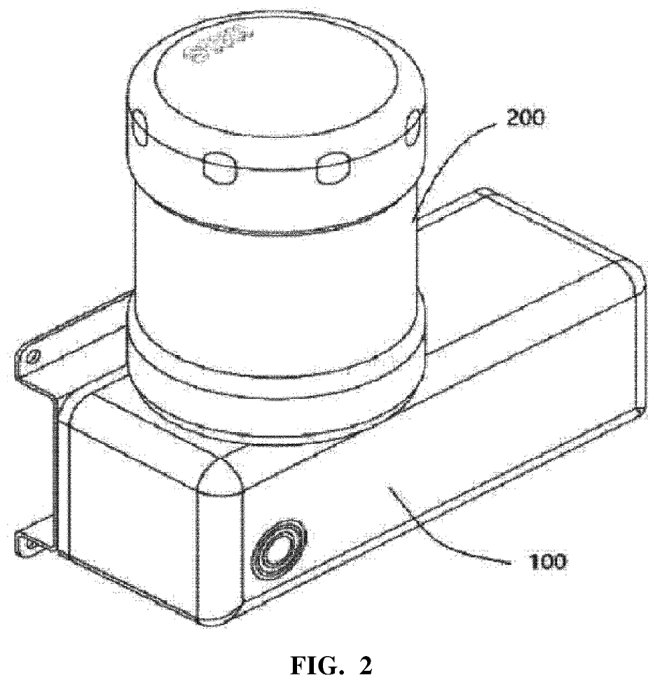

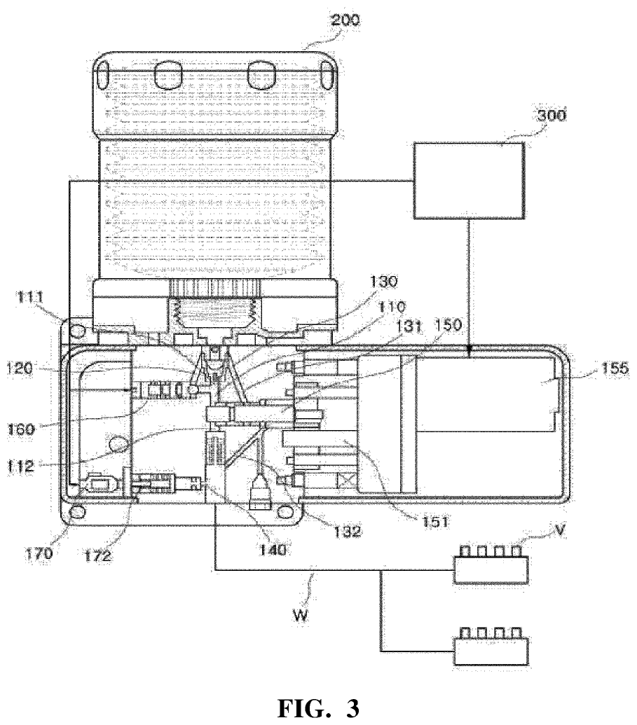

FIGS. 2 and 3 are front and side views of a lubricating oil pump device according to one embodiment of the present invention.

The lubricating oil pump device, as shown in FIGS. 2 and 3, includes a pump body 100 and a lubricating oil cartridge 200. Schematically, the lubricating oil pump device stores a lubricating oil in the lubricating oil cartridge 200 and supplies and discharges the lubricating oil stored in the lubricating oil cartridge 200 through a lubricating oil pipe formed in the pump body 100. Also, the lubricating oil pipe is connected to a discharge portion 112 of the lubricating oil pump device, and the lubricating oil discharged from the discharge portion 112 is supplied into an injection molding device through the lubricating oil pipe and a metering valve V.

Additionally, the lubricating oil pump device includes a fixing clip for fixing the device to a wall or another device.

A lubricating oil supply device according to one embodiment of the present invention includes the pump body 100 including a first pipe 110, a second pipe 120, third pipes 130, and a fourth pipe 140, the lubricating oil cartridge 200 installed on the pump body 100 to be connected to one end of the first pipe 110 and including a tank storing a lubricating oil and a housing covering the tank, a piston 150 moving forward and backward while repetitively opening and closing the third pipes 130 and transferring the lubricating oil through the first pipe 110, an actuator 155 moving the piston forward or backward, a relief valve 160 installed at a connecting part between the first pipe 110 and the other end of the second pipe 120, a pressure sensor 170 formed at one end of the fourth pipe 140 to measure a pressure of the lubricating oil in the pump body 100, and a control portion 300 controlling the actuator 155 and the relief valve 160 on the basis of information transmitted from the pressure sensor 170. Also, the pump body 100 may be connected to a plurality of such metering valves V through a lubricating oil pipe W.

The pump body 100 includes a suction portion 111 for receiving the lubricating oil stored in the lubricating oil cartridge 200 and the discharge portion 112 for discharging the suctioned lubricating oil. The suction portion 111 is disposed above the pump body 100, the discharge portion 112 is disposed below the pump body 100, and the first pipe 110 is formed between the suction portion 111 and the discharge portion 112 to transfer the lubricating oil while passing through the pump body. Also, at the suction portion 111 and the discharge portion 112, an incoming-side check valve is installed to prevent the lubricating oil moved to the first pipe 110 from flowing backward to the lubricating oil cartridge 200, and an outgoing-side check valve is installed to prevent the lubricating oil supplied to the lubricating oil supply pipe W from flowing backward to the first pipe 110. The first pipe 110 is connected to the second pipe 120, the third pipe 130, and the fourth pipe 140. The second pipe 120 connects a transfer pipe of the relief valve 160 located at a branch of the first pipe 110 to the first pipe 110 with the relief valve 160 therebetween so as to allow the first pipe 110 and the second pipe 120 to communicate with each other only when a shaft of the relief valve 160 is moved hindmost due to occurrence of a maximum pressure.

The third pipe 130 may include a first pressure relief pipe 131 connected to one side of the first pipe 110 and a second pressure relief pipe 132 connected to the other side of the first pipe 110. The first pressure relief pipe 131 and the second pressure relief pipe 132 may be connected to each other or not connected depending on a position of a shaft of the piston 150. In more detail, the piston 150 is movable to be located at a first position which is a maximum advancing point of the shaft of the piston 150 which moves forward and elicits the lubricating oil, a second position which is a maximum retreat point of an action of absorbing the lubricating oil while moving backward from the first position, and a third position which is a point where the shaft of the piston 150 moves back again from the second position and may open the first pressure relief pipe 131 and the second pressure relief pipe 132. Also, the pump body 100 includes a third pipe 130 formed therein, which is closed by the piston 150 when the piston 150 moves between the first position and the second position and is opened by the piston 150 when the piston 150 is moved backward to the third position. Accordingly, when supplying of the lubricating oil through the lubricating oil pipe is stopped, the piston 150 may be moved backward to the third position and a pressure at the discharge portion 112 may be relieved.

The fourth pipe 140 is one of branches of the first pipe 110 and may be formed adjacent to the discharge portion 112 in order to measure a pressure applied to the discharge portion 112. The fourth pipe 140 may be formed to be spaced to be parallel to or perpendicular to a movement pipe at which the relief valve 160 is located. The fourth pipe 140 is a pipe formed to measure a level of the pressure applied to the pump, and a pressure sensor 170 may be formed at an end of the corresponding pipe.

The piston 150 is inserted into the pump body 100 and reciprocates forward and backward along an operation path formed in the pump body 100. Since the piston 150 reciprocates forward and backward in the pump body 100, the lubricating oil is absorbed into the first pipe 110 of the pump body 100 through the suction portion 111 from the lubricating oil cartridge 200 and is discharged into the lubricating oil supply pipe W through the discharge portion 112. In more detail, when the piston 150 moves backward to the second position, the lubricating oil is absorbed into the first pipe 110 from the lubricating oil cartridge 200. When the piston 150 moves forward to the first position, the lubricating oil of the first pipe 110 is discharged into the lubricating oil supply pipe W through the discharge portion 112. Reciprocation of the piston 150 may be controlled by the control portion 300 and may be installed to be located at three or more positions (for example, the first position, the second position, and the third position). As described above, when reciprocation is performed between the first position and the second position, the reciprocating oil is pumped and supplied to the lubricating oil supply pipe W through the first pipe 110. When moving backward to the third position, the pressure in the pump may be relieved by opening the third pipe 130. The piston 150 may be operated by the actuator 155.

The actuator 155 may include an electric motor and the like capable of rotating forward or backward. The electric motor has a driving shaft rotated by a gear speed reduction tool and is disposed such that a shaft line of a shaft is parallel to an axial line of the piston 150. A coaxial screw shaft 151 may be installed at and extend from the driving shaft of the electric motor. The actuator 155 may include a link member which is engaged with the screw shaft 151 and is fixed and linked to a rear side part of the piston 150.

The link member may be supported to be slidable by two guide shafts and may be moved forward and backward by forward and backward rotation of the screw shaft 151 to move the piston 150 forward and backward.

The relief valve 160 is inserted into the pump body 100 and is generally installed for adjusting a pressure of the pump body 100. The relief valve 160 is connected to one side of the first pipe 110 and is located between the first pipe 110 and the second pipe 120 to return the lubricating oil to the suction portion 111 and/or the first pipe 110. The relief valve 160 includes a valve shaft and a spring, and a lubricating oil transfer path for returning the lubricating oil is formed in the valve shaft. In more detail, in an operation of the relief valve 160, the relief valve 160 stays in place after being moved forward maximally by the spring when a pressure is not present in the pump body 100 and is moved behind the valve shaft of the relief valve 160 when a pressure increases in the pump body 100. When the relief valve 160 has been moved behind maximally by the pressure inside the pump body 100, the lubricating oil transfer path formed in the relief valve 160 is connected to the second pipe 120 and the lubricating oil of the first pipe 110 is returned through the lubricating oil transfer path and the second pipe 120 of the relief valve 160. The lubricating oil is returned such that the pressure in the pump body 100 decreases.

The pressure sensor 170 is inserted into the pump body 100 to measure the pressure in the pump body 100. According to one embodiment of the present invention, the pressure sensor 170 is connected to the first pipe 110 through the fourth pipe 140. According to another embodiment of the present invention, the pressure sensor 170 is connected to the third pipe 130 for relieving the pressure in the pump body 100 through the fourth pipe 140. The pressure sensor 170 senses the pressure in the pump body 100 through the fourth pipe 140 and transmits a pressure relief signal to the control portion 300 when the pressure in the pump body 100 is greater than or equal to a preset pressure.

In more detail, with respect to sensing the pressure, by the pressure sensor 170, through the fourth pipe 140, a pressure detection valve 172 measuring a pressure transferred from the fourth pipe 140 through a spring adjusting screw setting a particular pressure and a mobile shaft is further included. The pressure detection valve 172 transfers the measured pressure to the pressure sensor 170. Accordingly, it is possible to detect a precise pressure of an area adjacent to the discharge portion 112.

That is, it is possible detect a precise pressure of the discharge portion 112 by detecting a pressure through the fourth pipe 140 connected to the discharge portion 112 in an area outside an area partitioned between an incoming side check valve and an outgoing side check valve in addition to a pressure in the area partitioned between the incoming side check valve for preventing the lubricating oil moved to the first pipe 110 between the suction portion 111 and the discharge portion 112 from flowing backward to the lubricating oil cartridge 200 and the outgoing side check valve for preventing the lubricating oil supplied to the lubricating oil supply pipe W between the suction portion 111 and the discharge portion 112 from flowing backward to the first pipe 110.

In other words, a pressure between the area partitioned by the incoming side check valve and the outgoing side check valve and a pressure at an outlet side in the discharge portion 112 connected to the lubricating oil supply pipe W may be distinguished from each other. It is possible to sense the pressure in the pump body 100 through the fourth pipe 140 formed between the incoming side check valve and the lubricating oil supply pipe W. Accordingly, it is possible to accurately determine whether the lubricating oil is provided more or less to the lubricating oil supply pipe W by sensing the precise of the area adjacent to the outlet side in the pump body 100. A difference may occur between the pressure at the first pipe 110 between the incoming side check valve and the outgoing side check valve and the pressure at the fourth pipe 140 near the lubricating oil supply pipe W. The pressure at the fourth pipe 140 may be substantially equal to the pressure at the outlet side which is outside the incoming side check valve and formed in a space between the incoming side check valve and the lubricating oil supply pipe W. Here, since the pressure sensor 170 senses the pressure through the fourth pipe 140, it is possible to measure a precise pressure closest to a pressure at an outlet among the area partitioned by pressure in the pump body 100 such that the lubricating oil pump device may perform a precise operation.

Meanwhile, although not separately shown in the drawings, the lubricating oil pump device according to the present invention may adjust a movement distance of the mobile shaft by adjusting the spring adjusting screw of the pressure detection valve 172 and may change settings of the particular pressure of the pressure detection valve 172 by adjusting the movement distance of the mobile shaft. That is, in order to measure the pressure transferred through the fourth pipe 140₇ a pressure is detected by the pressure detection valve 172, which measures the pressure transferred from the fourth pipe 140 using the spring adjusting screw setting a particular pressure and the mobile shaft, and is transferred to the pressure sensor 170 so as to detect a precise pressure near the discharge portion 112. Also, since settings of the particular pressure may be changed by adjusting a movement interval (distance) of the mobile shaft by adjusting the spring adjusting screw, a worker may change the settings of a particular pressure desired by a user depending on a service environment of the lubricating oil pump device or may adjust a discharge amount and the like of the lubricating oil by changing the settings of the particular pressure as necessary. In other words, the settings of the particular pressure may be easily changed using only a simple operation of the spring adjusting screw.

Here, the user may determine a particular pressure value in consideration of durability of the pump body 100. A value of a pressure at which the pressure sensor 170 operates may be set (for example, 100 bar) in consideration of the durability of the pump body 100. The user may set an operational pressure value (for example, 80 bars) by operating a display portion. Since the operational pressure value is changed by the user, the durability of the pump body 100 may be increased and a level of a pressure applied to the metering valve V and the like may be controlled. When the pressure sensor is attached to an end of the relief valve 160, a pressure relief signal is operated only when the relief valve 160 moves backward to a hindmost end such that it is impossible to relieve a pressure inside the pump body 100 at a pressure desired by the user. Here, the fourth pipe 140 may be formed to be spaced apart to be parallel or perpendicular to the lubricating oil transfer path on which the relief valve 160 is located in an area adjacent to the discharge portion 112 so as to measure a precise pressure applied thereto. Also, the pressure sensor 170 may include a pressure detection shaft and a pressure sensor which move backward according to a pressure in order to detect a pressure generated by the discharge portion 112 adjacent to the fourth pipe 140 and may transmit a measured pressure value to the control portion 300 to maintain uniform pressure of the discharge portion 112. Also, the pressure detection shaft and the pressure sensor may be located on one side surface of the pump body 100 or may be located in a rear surface bracket attachment space of the pump body 100.

The control portion 300 controls a reciprocation operation of the piston 150. The control portion 300 may continuously receive the pressure inside the pump body 100 from the pressure sensor 170. When the pressure inside the pump body 100 is greater than or equal to a particular pressure preset by the user, a pressure relief signal is generated. In response thereto, the piston 150 is controlled to be moved to a hindmost place which is the third position simultaneously while the shaft of the relief valve 160 may be moved backward. In more detail, when a pressure measured by the pressure sensor 170 is greater than or equal to a particular pressure, the piston 150 is moved to the hindmost place, which is the third position, by the pressure relief signal such that the third pipe 130 formed between the piston 150 and the first pipe 110 is opened. The opened third pipe 130 may operate as a lubricating oil relief path and may decrease a pressure inside the pump body 100.

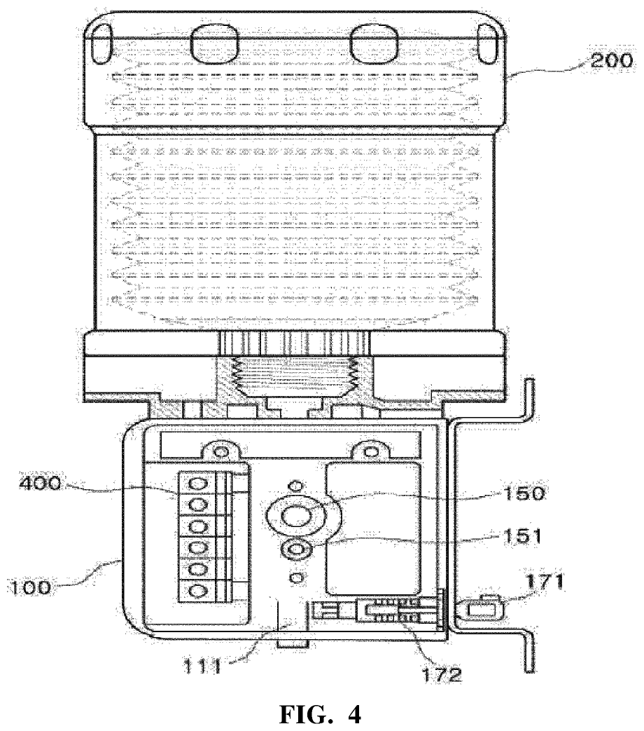

The control portion is not limited to being controllable through the display portion and may be controlled while being connected to another device through wireless communication (for example, Bluetooth, Wi-bro, high speed downlink packet access (HSDPA), Wi-Fi, Wi-Max, Zigbee, ultra wideband (UWB), infrared data association (IrDA), SWAP, and the like). FIG. 4 is a cross-sectional view of a lubricating oil pump device according to another embodiment of the present invention.

Referring to FIG. 4, in the lubricating oil pump device according to the present invention, the pressure detection valve 172 of a pressure sensor 171 may be formed to be spaced apart from the lubricating oil transfer pipe of a place in which the relief valve 160 is located while being perpendicular thereto. The pressure sensor 171, as shown in FIG. 4, may be located on the fourth pipe 140 and may sense a precise pressure of the discharge portion 112 transferred from the fourth pipe 140 using the pressure detection valve 172.

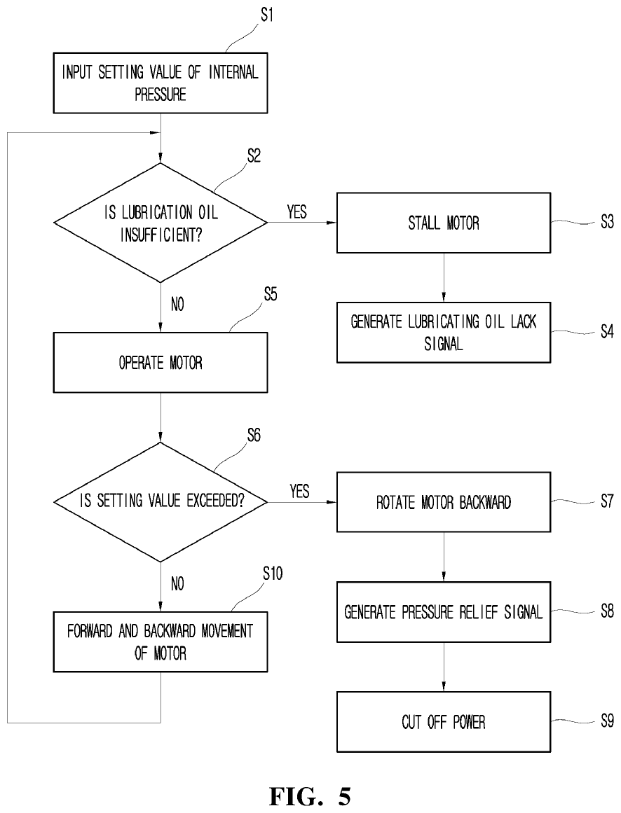

FIG. 5 is a flowchart illustrating controlling, by a control portion, of the lubricating oil pump device according to the present invention.

Referring to FIG. 5, the lubricating oil pump device may be driven through an operation 51 in which a user inputs an internal pressure setting value. Prior to this, an operation of applying power to the lubricating oil pump device may be included but is not shown. The internal setting pressure value of the lubricating oil pump device may be set by the user but may be set to be a particular pressure (for example, 100 bars) according to internal properties of the pump body 100. When it is determined that the corresponding particular pressure has no usability problems, a subsequent operation may be performed without performing an operation of inputting an internal pressure setting value.

Since it is impossible to drive the lubricating oil pump device when the lubricating oil is inadequate in the lubricating oil cartridge 200 coupled with the lubricating oil pump device, an operation S2 of checking whether the lubricating oil is sufficient in the lubricating oil cartridge 200 may be performed. It may be measured by a flow rate measuring sensor located on the lubricating oil cartridge 200 whether a lubricating oil is adequate, and the sensor will be omitted. When the lubricating oil in the lubricating oil cartridge 200 is inadequate, the control portion 300 automatically transmits a motor stall signal to the actuator 155 and an operation S3 of stalling a motor is performed therethrough. Also, the control portion 300 may generate a lubricating oil lack signal (S4) to display a lack of a lubricating oil on the display portion or to generate an alarm sound like an alarm and the like. Also, the lubricating oil lack signal may be transmitted to another device connected through wireless communication.

When the lubricating oil cartridge 200 does not lack the lubricating oil, the control portion 300 transmits a signal for rotating the motor forward to the actuator 155, and the actuator 155 performs an operation S5 of operating the motor. The operation S5 of operating the motor means an operation of performing forward and backward movement of the piston 150 and should not be interpreted as being limited to a forward rotation or a backward rotation of the motor.

When the lubricating oil pump device is operated by driving the motor, the pressure sensor 170 performs an operation S6 of measuring whether an internal pressure of the pump body 100 exceeds a preset pressure setting value by measuring a pressure of an area adjacent to the discharge portion 112.

When the internal pressure of the pump body 100 exceeds the preset pressure setting value, the control portion 300 moves the piston 150 to the third position by rotating the motor backward (S7). Also, the control portion 300 generates a pressure relief signal to generate a pressure relief path when the piston 150 is located at the third position (S8). When the pressure is relieved, power of the lubricating oil pump device is cut off for a certain time such that a pump operation may be stopped and the pressure inside the pump body 100 may be decreased.

When the pressure inside the pump body 100 does not exceed the preset pressure setting value, the piston 150 continuously performs the forward and backward movement (S10) and the control portion 300 may continuously sense whether the lubricating oil is inadequate and whether the internal pressure exceeds the preset pressure setting value.

According to the exemplary embodiments of the present disclosure, at least following effects are provided.

In a lubricating oil pump device provided herein, a pressure at a pipe through which a lubricating oil moves may be precisely measured. When the measured pressure is greater than or equal to a particular preset pressure, a detection signal is transmitted to a control portion such that the control portion controls an operation of a piston to relieve a pressure inside a pump body. The lubricating pump device may be prevented from being damaged by relieving a pressure greater than or equal to a maximum point inside the pump body of the lubricating oil pump device. Accordingly, according to the present invention, the pressure greater than or equal to the maximum point may be safely relieved using a relief valve. Since a lubricating oil supply pressure detection piston control portion is separately used so as to set a precise pressure within a pressure use range, it is possible to prevent a change in a discharge amount of the lubricating oil and to supply a certain amount of the lubricating oil at a lubricating oil distribution supply side.

Effects according to the present disclosure are not restricted by the above exemplified content, and a variety of effects are included in the specification.

The above description is merely for exemplarily describing the present invention, and a variety of modifications thereof may be made by one of ordinary skill in the art, to which the present invention pertains, without departing from the essential features of the present invention. Accordingly, the embodiments disclosed herein are not intended to limit but explain the present invention, and the concept and scope of the present invention should not be limited by the above embodiments. The scope of the present invention should be interpreted by the following claims and all technology within the equivalent scope thereof should be interpreted as being included in the scope of the present invention.

1. A lubricating oil pump device comprising a pump body (100) and a lubricating oil cartridge (200),
wherein the pump body (100) comprises:
a suction portion (111) which is connected to the lubricating oil cartridge (200) and receives a lubricating oil from the lubricating oil cartridge (200);
a discharge portion (112) which is connected to a lubricating oil supply pipe (W) and supplies the lubricating oil to the lubricating oil supply pipe (W);
a piston (150) which reciprocates in the pump body (100) to supply the lubricating oil to the pump body (100) from the lubricating oil cartridge (200);
a relief valve (160) configured to adjust a pressure inside the pump body (100);
a pressure sensor (170) configured to measure the pressure inside the pump body (100);
a control portion (300) which controls an operation of the piston (150) and an operation of the relief valve (160);
a first pipe (110) formed between the suction portion (111) and the discharge portion (112);
an incoming side check valve which prevents the lubricating oil moved to the first pipe (110) between the suction portion (111) and the discharge portion (112) from flowing backward to the lubricating oil cartridge (200);
an outgoing side check valve which prevents the lubricating oil supplied to the lubricating oil supply pipe (W) between the suction portion (111) and the discharge portion (112) from flowing backward to the first pipe (110);
a second pipe (120) formed between the first pipe (110) and the relief valve (160);
a third pipe (130) formed between the first pipe (110) and the piston (150); and
a fourth pipe (140) formed between the first pipe (110) and the pressure sensor (170) and formed between the outgoing side check valve and the lubricating oil supply pipe (W),
wherein the pressure sensor (170) senses a pressure inside the pump body (100) through the fourth pipe (140), and
wherein the relief valve (160) is connected to the first pipe (110) and the second pipe (120),
wherein when the detected pressure exceeds a pressure preset by a user, the control portion (300) controls an operation of the piston (150) to open the third pipe (130) using a pressure relief signal.

2. The lubricating oil pump device of claim 1, wherein the relief valve (160) comprises a spring and a valve shaft, and
wherein the valve shaft comprises a lubricating oil transfer path for returning the lubricating oil.

3. The lubricating oil pump device of claim 1, wherein the fourth pipe (140) is formed in an area adjacent to the discharge portion (112) and is spaced apart from and parallel to a transfer pipe at which the relief valve (160) is formed.

4. The lubricating oil pump device of claim 1, wherein the fourth pipe (140) is formed in an area adjacent to the discharge portion (112) and is spaced apart from and perpendicular to a transfer pipe at which the relief valve (160) is formed.

5. A lubricating oil pump device comprising a pump body (100) and a lubricating oil cartridge (200),
wherein the pump body (100) comprises:
a suction portion (111) which is connected to the lubricating oil cartridge (200) and receives a lubricating oil from the lubricating oil cartridge (200);
a discharge portion (112) which is connected to a lubricating oil supply pipe (W) and supplies the lubricating oil to the lubricating oil supply pipe (W);
a piston (150) which reciprocates in the pump body (100) to supply the lubricating oil to the pump body (100) from the lubricating oil cartridge (200);
a relief valve (160) configured to adjust a pressure inside the pump body (100);
a pressure sensor (170) configured to measure the pressure inside the pump body (100);
a control portion (300) which controls an operation of the piston (150);
a first pipe (110) formed between the suction portion (111) and the discharge portion (112);
an incoming side check valve which prevents the lubricating oil moved to the first pipe (110) between the suction portion (111) and the discharge portion (112) from flowing backward to the lubricating oil cartridge (200);
an outgoing side check valve which prevents the lubricating oil supplied to the lubricating oil supply pipe (W) between the suction portion (111) and the discharge portion (112) from flowing backward to the first pipe (110);
a second pipe (120) formed between the first pipe (110) and the relief valve (160);
a third pipe (130) formed between the first pipe (110) and the piston (150); and
a fourth pipe (140) formed between the outgoing side check valve and the pressure sensor (170) and formed between the outgoing side check valve and the lubricating oil supply pipe (W),
wherein the pressure sensor (170) detects a pressure inside the pump body (100) through the fourth pipe (140) and is configured to transmit a detection signal to the control portion (300) when the detected pressure is greater than or equal to a pressure set by a user,
wherein the relief valve (160) is connected to the first pipe (110) and the second pipe (120), and
wherein the control portion (300) receives the detection signal from the pressure sensor (170) and controls an operation of the piston (150) to open the third pipe (130).

6. The lubricating oil pump device of claim 1, wherein the pressure sensor (170) comprises a shaft and a pressure sensor which move backward according to a pressure in order to detect a pressure generated by the discharge portion (112) adjacent to the fourth pipe (140) and transmits a measured pressure value to the control portion (300) to maintain uniform pressure of the discharge portion (112).

7. The lubricating oil pump device of claim 6, wherein the pressure detection shaft and the pressure sensor are located on one side surface of the pump body (100) or located in a rear bracket attachment space of the pump body (100).

8. The lubricating oil pump device of claim 1, further comprising a pressure detection valve (172) which measures a pressure transferred from the fourth pipe (140) through a spring adjusting screw, which sets a particular pressure, and a mobile shaft,
wherein the pressure detection valve (172) transmits the measured pressure to the pressure sensor (170).

9. The lubricating oil pump device of claim 8, wherein a movement distance of the mobile shaft is adjusted by adjusting the spring adjusting screw of the pressure detection valve (172), and settings of the particular pressure of the pressure detection valve (172) are changed by adjusting the movement distance of the mobile shaft.
